(19) United States
(12) Patent Application Publication
(10) Pub. No.: US 2026/0148400 A1
(43) Pub. Date: May 28, 2026

(54) INFORMATION PROCESSING DEVICE, INFORMATION PROCESSING METHOD, AND PROGRAM

(71) Applicant: Sony Semiconductor Solutions Corporation, Kanagawa (JP)

(72) Inventor: Kensuke Ikeya, Kanagawa (JP)

(21) Appl. No.: 19/100,304

(22) PCT Filed: Aug. 29, 2023
(86) PCT No.: PCT/JP2023/031090

§ 371 Date: Jan. 31, 2025

(30) Foreign Application Priority Data
Sep. 13, 2022 (JP) 2022-145397

(51) Int. Cl. G06T 7/521; G01S 7/4865; G01S 17/894

(52) U.S. Cl. CPC G06T 7/521; G01S 7/4865; G01S 17/894; G06T 2207/10024; G06T 2207/10028; G06T 2207/20072; G06T 2207/20076; G06T 2207/20192

(57) ABSTRACT

Information processing with estimation of a distance value with high accuracy is disclosed. In one example, an information processing device includes a cost volume generation unit that generates a cost volume indicating a probability distribution of a distance to an object appearing in each pixel of a captured image on the basis of distance measurement data acquired by a ToF sensor. The technology can be applied to, for example, an information processing system that performs upsampling of a distance value acquired by a ToF sensor.

### TECHNICAL FIELD

The present technology relates to an information processing device, an information processing method, and a program, and more particularly, to an information processing device, an information processing method, and a program capable of accurately estimating a distance value.

### BACKGROUND ART

A direct time of flight (ToF) type ToF sensor detects reflected light, which is pulse light reflected by an object, using a light receiving element referred to as a single photon avalanche diode (SPAD) in each pixel for light reception. The ToF sensor repeatedly performs, for example, light emission of spot-shaped pulse light and light reception of reflected light, generates a histogram of the time of flight of the pulse light, and calculates a distance to the object on the basis of the time of flight at a peak in the histogram.

Since the spot-shaped pulse light is generally sparse pulse light, pixels that detect the reflected light are also sparse according to a spot diameter and an irradiation area. Therefore, the distance value measured by the ToF sensor is a sparse distance value. For example, Patent Documents 1 to 3 propose techniques of upsampling a sparse distance value measured by a ToF sensor and estimating a dense distance value.

### CITATION LIST

### Patent Document

Patent Document 1: Japanese Translation of PCT International Application Publication No. 2018-537742
Patent Document 2: Japanese Patent Application Laid-Open No. 2021-174406
Patent Document 3: Japanese Patent Application Laid-Open No. 2017-103756

### SUMMARY OF THE INVENTION

### Problems to be Solved by the Invention

In the techniques described in Patent Documents 1 to 3, the accuracy of the estimated dense distance value may be low. For example, the accuracy of the distance value of a contour portion of an object may be significantly reduced.

The present technology has been made in view of such a situation, and an object thereof is to enable estimation of a distance value with high accuracy.

### Solutions to Problems

An information processing device according to one aspect of the present technology includes a cost volume generation unit that generates a cost volume indicating a probability distribution of a distance to an object appearing in each pixel of a captured image on the basis of distance measurement data acquired by a ToF sensor.

In an information processing method according to an aspect of the present technology, an information processing device generates a cost volume indicating a probability distribution of a distance to an object appearing in each pixel of a captured image on the basis of distance measurement data acquired by a ToF sensor.

A program according to one aspect of the present technology causes a computer to execute processing of generating a cost volume indicating a probability distribution of a distance to an object appearing in each pixel of a captured image on the basis of distance measurement data acquired by a ToF sensor.

In one aspect of the present technology, the cost volume indicating the probability distribution of a distance to the object appearing in each pixel of the captured image is generated on the basis of the distance measurement data acquired by the ToF sensor.

### BRIEF DESCRIPTION OF DRAWINGS

FIG. 1 is a block diagram illustrating a configuration example of an information processing system according to a first embodiment of the present technology.

FIG. 2 is a diagram illustrating an example of a distance measurement range of a ToF sensor and an imaging range of an image sensor.

FIG. 3 is a diagram illustrating an example of a depth map.

FIG. 4 is a diagram illustrating an example of a three-dimensional model.

FIG. 5 is a diagram for explaining a conventional technology for acquiring a dense distance value and the present technology.

FIG. 6 is a block diagram illustrating a functional configuration example of each equipment of an information processing system.

FIG. 7 is a flowchart illustrating processing performed by the information processing system.

FIG. 8 is a block diagram illustrating a functional configuration example of each equipment of an information processing system according to a second embodiment of the present technology.

FIG. 9 is a diagram illustrating an example of a probability distribution of distance values.

FIG. 10 is a diagram for comparing a depth map generated by stereo matching with a depth map generated by the present technology.

FIG. 11 is a diagram illustrating a display example of a 3D content.

FIG. 12 is a diagram illustrating an example of a depth map acquired by an in-vehicle stereo camera.

FIG. 13 is a block diagram illustrating a configuration example of hardware of a computer.

### MODE FOR CARRYING OUT THE INVENTION

Hereinafter, modes for carrying out the present technology will be described. The description will be given in the following order.
1. First embodiment of information processing system
2. Configuration and operation of each equipment
3. Second embodiment of information processing system
4. Use case

### 1. First Embodiment of Information Processing System

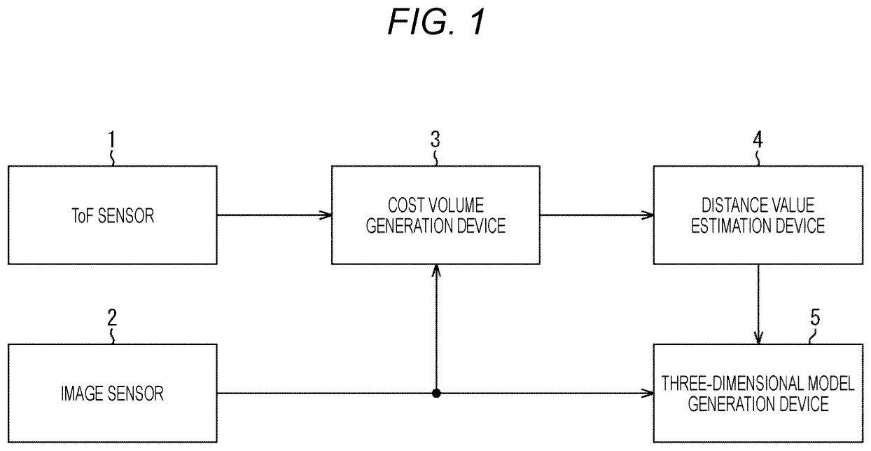

FIG. 1 is a block diagram illustrating a configuration example of an information processing system according to a first embodiment of the present technology.

The information processing system in FIG. 1 includes a ToF sensor 1, an image sensor 2, a cost volume generation device 3, a distance value estimation device 4, and a three-dimensional model generation device 5.

The ToF sensor 1 is a distance measurement sensor that acquires distance measurement data indicating a distance to an object by, for example, a direct ToF method, and acquires distance measurement data for the same object as an object imaged by the image sensor 2. The ToF sensor 1 repeatedly performs, for example, emission of spot-shaped pulse light and reception of reflected light, generates a histogram of the time of flight of the pulse light, and calculates a distance to the object on the basis of the time of flight that is a peak in the histogram.

Since the spot-shaped pulse light is generally sparse pulse light, pixels (distance measurement points) that detect the reflected light are also sparse according to a spot diameter and an irradiation area. Therefore, the distance value measured by the ToF sensor 1 is a sparse distance value. The ToF sensor 1 supplies the acquired distance measurement data for each distance measurement point to the cost volume generation device 3.

The image sensor 2 images a predetermined object as a subject to generate a captured image (for example, an RGB image), and supplies the captured image to the cost volume generation device 3 and the three-dimensional model generation device 5.

A relative positional relationship between the ToF sensor 1 and the image sensor 2 is fixed, and a distance measurement range of the ToF sensor 1 and an imaging range of the image sensor 2 are calibrated. In other words, the distance measurement range of the ToF sensor 1 and the imaging range of the image sensor 2 are at least partially the same, and a correspondence relationship between the distance measurement point of the ToF sensor 1 and each pixel of the image sensor 2 is known.

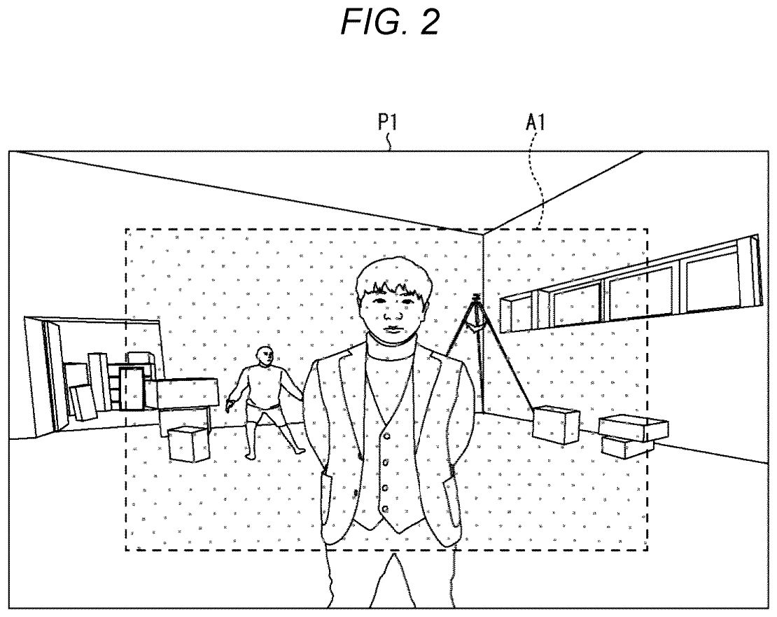

Since the distance measurement range of the ToF sensor 1 and the imaging range of the image sensor 2 are calibrated, as illustrated in FIG. 2, a distance measurement range A1 of the ToF sensor 1 can be accurately superimposed on an RGB image P1 acquired by the image sensor 2. In the example of FIG. 2, a central region in the imaging range of the image sensor 2 is the distance measurement range A1 of the ToF sensor 1. In FIG. 2, a point group in the distance measurement range A1 indicates a distance measurement point of the ToF sensor 1. The distance measurement point of the ToF sensor 1 is, for example, sparser than the pixels of the RGB image P1.

Note that, in the following description, in order to simplify the description, it is assumed that the positions (attitudes) of the ToF sensor 1 and the image sensor 2 are the same, assuming that a difference between the positions of the ToF sensor 1 and the image sensor 2 can be ignored.

Returning to FIG. 1, the cost volume generation device 3 is an information processing device that generates a cost volume indicating a probability distribution of a distance value to an object appearing in each pixel of an RGB image on the basis of distance measurement data supplied from the ToF sensor 1. The cost volume generation device 3 supplies the generated cost volume to the distance value estimation device 4.

The distance value estimation device 4 upsamples the sparse distance value measured by the ToF sensor 1 on the basis of the cost volume supplied from the cost volume generation device 3, and estimates a distance value for a point denser than the distance measurement point of the ToF sensor 1. The distance value estimation device 4 estimates a dense distance value to generate a depth map having the same resolution as a resolution of the RGB image, for example.

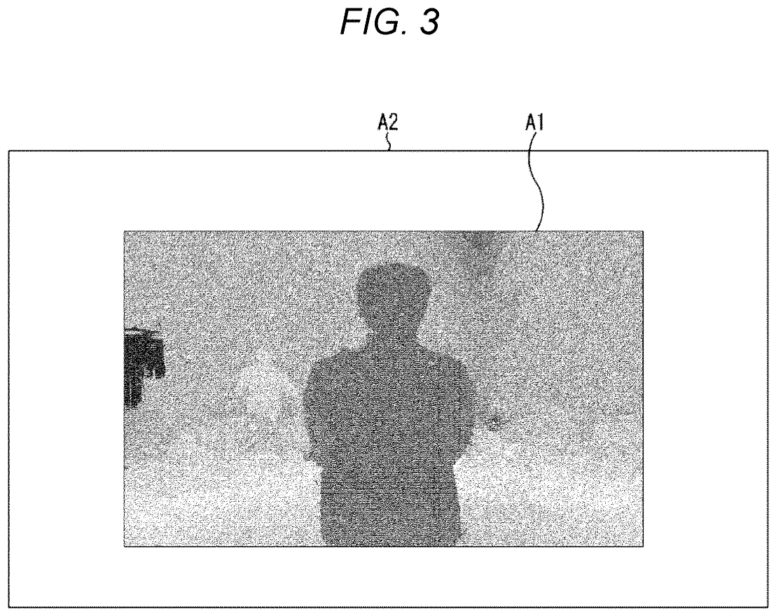

As illustrated in FIG. 3, the depth map indicates a distance value for each pixel within the distance measurement range A1 of the ToF sensor 1 in an imaging range A2 of the image sensor 2. In the example of FIG. 3, the distance to the object appearing in each pixel is indicated by color shading.

The distance value estimation device 4 in FIG. 1 supplies the generated depth map to the three-dimensional model generation device 5.

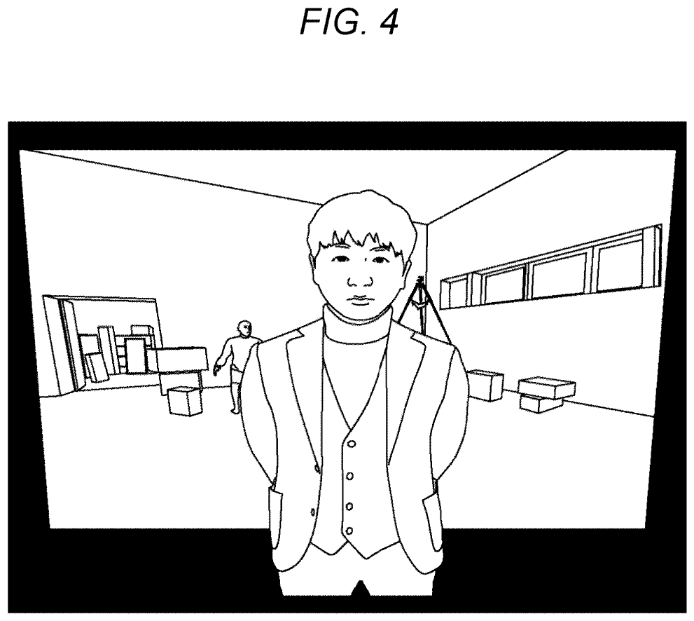

The three-dimensional model generation device 5 generates a three-dimensional model on the basis of the RGB image supplied from the image sensor 2 and the depth map supplied from the distance value estimation device 4. For example, as illustrated in FIG. 4, the three-dimensional model is configured such that an object appearing in an RGB image is disposed at a position in a depth direction according to a distance from the ToF sensor 1. In the example of FIG. 4, a person appearing at the center of the RGB image P1 of FIG. 2 is disposed on a front side of a background.

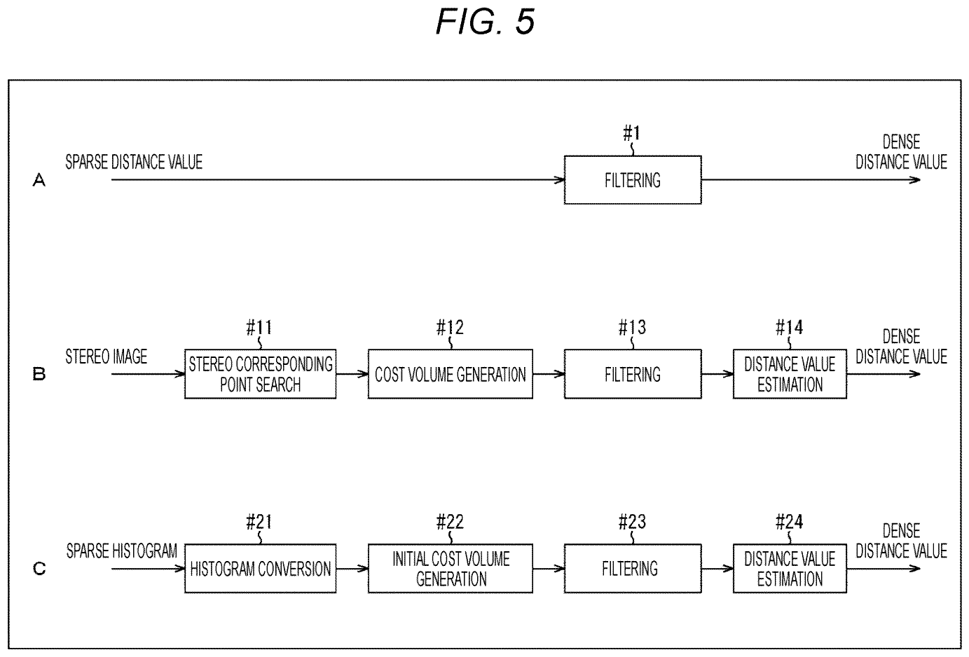

FIG. 5 is a diagram for explaining a conventional technology for acquiring a dense distance value and the present technology.

A of FIG. 5 illustrates a flow of acquiring a dense distance value with a conventional upsampling technology. In the conventional upsampling technology, as indicated by #1 in A of FIG. 5, the dense distance value is acquired by filtering the sparse distance value measured by the ToF sensor.

B of FIG. 5 illustrates a flow of acquiring a dense distance value by conventional stereo matching. In the conventional stereo matching, first, as indicated by #11 in B of FIG. 5, a stereo corresponding point search is performed on a stereo image captured by a stereo camera, and corresponding points between two images constituting the stereo image are acquired.

Next, as indicated by #12 in B of FIG. 5, a cost volume indicating a probability distribution of a distance value to an object appearing in each pixel of the stereo image is generated. In the cost volume in the conventional stereo matching, an existence probability of the object calculated on the basis of the similarity of the corresponding points between the two images is stored for each distance value (sample distance value) from the stereo camera sampled at a predetermined interval.

Next, as indicated by #13 in B of FIG. 5, the cost volume is filtered.

Next, as indicated by #14 in B of FIG. 5, a distance value (dense distance value) to the object appearing in each pixel of the stereo image is estimated on the basis of the filtered cost volume.

C of FIG. 5 illustrates a flow of acquiring a dense distance value in the present technology. In the present technology, a cost volume is generated on the basis of a histogram as distance measurement data acquired by the ToF sensor 1 instead of the similarity of the corresponding points of the stereo image.

The histogram acquired by the ToF sensor 1 is, for example, a histogram in which the time of flight of pulse light corresponding to a distance to the object is set as a bin, and the frequency of each bin indicates the number of photons detected in the time of flight of each bin. In the ToF sensor 1, the histogram is acquired for each distance measurement point that is sparse.

Since the histogram acquired by the ToF sensor 1 is essentially different from the similarity of the corresponding points in the stereo matching, it is not preferable to store the histogram as it is in the cost volume.

In the present technology, first, as illustrated in #21 in C of FIG. 5, conversion based on the characteristics of the ToF sensor 1 is performed on the sparse histogram acquired by the ToF sensor 1. First, the time of flight of each bin in the histogram is converted into a sample distance value that is a distance value sampled at a predetermined interval. Next, a conversion indicated by the following Formula (1) is performed on the histogram.

$$\begin{matrix}[ Math . 1 ] & \\ {H}_{p\_dToF , d}^{′} = \{ \begin{matrix}{H}_{p\_dToF , d} \times {d}^{2} , {H}_{p\_dToF , d} \geq T \\ c , {H}_{p\_dToF , d} < T\end{matrix} & ( 1 )\end{matrix}$$

In Formula (1), H′_{p_dToF,d} indicates the number of photons in the bin of a sample distance value d for a distance measurement point p_dToF in the histogram after conversion, and H_{p_dToF,d} indicates the number of photons in the bin of the sample distance value d for the distance measurement point p_dToF in the histogram before conversion. Furthermore, in Formula (1), T represents a predetermined threshold, and c represents a cost of a predetermined value. For example, a value smaller than H_{p_dToF,d}×d² is set as the cost c.

In Formula (1), two ingenuity based on the characteristics of the ToF sensor 1 is applied to the histogram. A first ingenuity is to apply an attenuation model of the number of photons according to a distance value. The number of photons emitted from the ToF sensor 1 is attenuated by the square of the distance until the photons are reflected from the object and received by the ToF sensor 1. In Formula (1), by multiplying the number of photons by the square of the distance value, the influence of attenuation of the number of photons due to the distance is canceled.

The second ingenuity is to reduce the influence of noise due to natural light. Since the ToF sensor 1 detects the natural light together with the photons reflected from the object, the number of photons in each bin of the histogram includes noise due to the natural light. In Formula (1), in a case where the number of photons H_{p_dToF,d} is smaller than the threshold T, the cost c is assigned as the number of photons H′_{p_dToF,d} after conversion, so that the number of photons in a bin in which only photons of the natural light are counted is set to a predetermined value, and the influence of the noise due to the natural light is reduced.

Next, as indicated by #22 in C of FIG. 5, an initial cost volume is generated on the basis of the converted histogram. An initial cost volume C_{p,d} is expressed by the following Formula (2).

$$\begin{matrix}[ Math . 2 ] & \\ {C}_{p , d} = \{ \begin{matrix}- {H}_{p\_dToF , d}^{′} , p = p\_dToF \\ - c , p \neq p\_dToF\end{matrix} & ( 2 )\end{matrix}$$

In the initial cost volume C_{p,d}, a cost indicating a probability that an object is present at a position separated from the ToF sensor 1 by the sample distance value d with respect to a pixel position p of the depth map is stored.

In the cost volume in stereo matching, costs (probability that an object exists) corresponding to distance values for all pixels of a stereo image are stored. Since the distance measurement point of the ToF sensor 1 is sparse, it is necessary to calculate the costs corresponding to the distance values for all the pixels of the depth map generated by the information processing system of the present technology.

In Formula (2), (—H′_{p_dToF,d}) is stored as the cost for the pixel position p (=p_dToF) corresponding to the distance measurement point of the ToF sensor 1, and (−c) is stored as the costs corresponding to all the distance values for the pixel positions p (≠p_dToF) other than the pixel position corresponding to the distance measurement point. In other words, a certain probability distribution is stored in the initial cost volume as a probability distribution that an object is present at the pixel positions p other than the pixel position corresponding to the distance measurement point.

Next, as indicated by #23 in C of FIG. 5, the initial cost volume is filtered by the edge-preserved filter. A cost volume C′_{p,d} after filtering is expressed by the following Formula (3).

$$\begin{matrix}[ Math . 3 ] & \\ {C}_{p , d}^{′} = {\sum }_{q} {W}_{p , q} ( I ) {C}_{q , d} & ( 3 )\end{matrix}$$

In Formula (3), W represents an edge-preserved filter that calculates the pixel value at the pixel position p with reference to the pixel value of the pixel in a predetermined block, and q represents a pixel position in a block referred to in the edge-preserved filter. As the edge-preserved filter, for example, a guided filter is used. In Formula (3), I represents a guide image, and an RGB image acquired by the image sensor 2 is used as the guide image I, for example.

Next, as illustrated in #24 in C of FIG. 5, a distance value (dense distance value) for each pixel of the depth map is estimated on the basis of the filtered cost volume. A distance value fₚ for each pixel position p is expressed by, for example, the following Formula (4).

$$\begin{matrix}[ Math . 4 ] & \\ {f}_{p} = Subpixel depth estimation ( {C}_{p , d}^{′} ) & ( 4 )\end{matrix}$$

In Formula (4), subpixel estimation (such as equiangular linear fitting and parabolic fitting) for each pixel of the depth map is performed on the basis of the filtered cost volume C′_{p,d}, whereby the dense distance value fₚ is calculated.

Note that, as indicated by the following Formula (5), the dense distance value fₚ may be estimated by setting the distance value with the minimum cost as the distance value for each pixel.

$$\begin{matrix}[ Math . 5 ] & \\ {f}_{p} = arg {min}_{d} {C}_{p , d}^{′} & ( 5 )\end{matrix}$$

As described above, in the information processing system of the present technology, the cost volume indicating the probability distribution of the distance to the object appearing in each pixel of the RGB image is generated on the basis of the sparse histogram acquired by the ToF sensor 1. The cost volume is generated by filtering the initial cost volume based on the histogram using the edge-preserved filter.

In the cost volume generation device 3, data indicating the number of photons of (the number of distance measurement points of the ToF sensor 1)×(the number of bins) is input as histogram data. Furthermore, in the cost volume generation device 3, the data of the cost of (the resolution of the RGB image)×(the number of samples of the distance value in the cost volume) is output as the data of the cost volume.

The information processing system of the present technology can accurately estimate the distance values at points other than the distance measurement point of the ToF sensor 1 by three-dimensionally estimating the distance value using the cost volume. In particular, the information processing system can accurately estimate the distance values for the contour portion of the object.

### 2. Configuration and Operation of Each Equipment

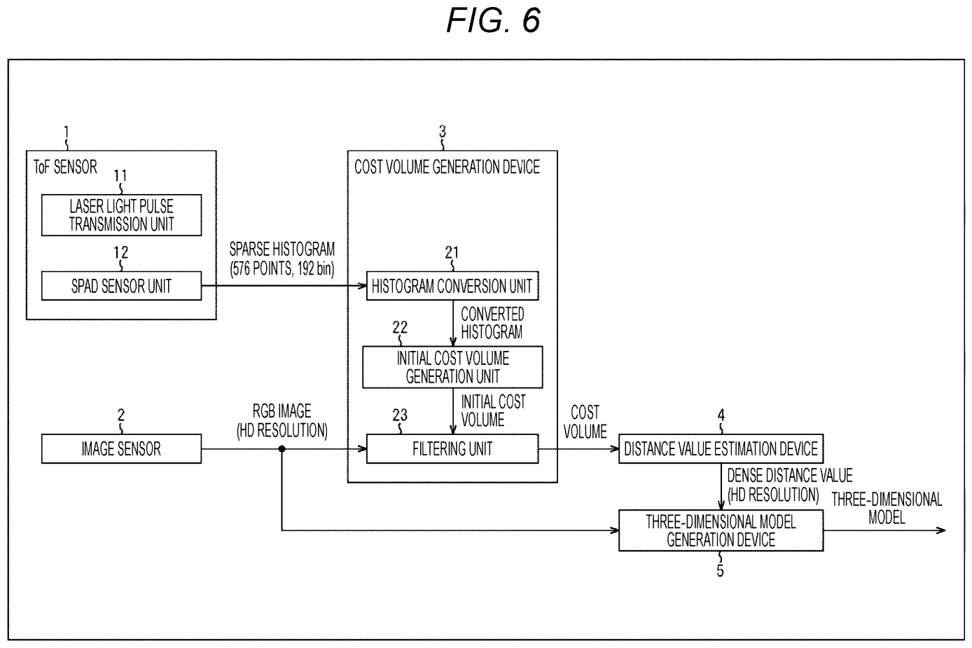

FIG. 6 is a block diagram illustrating a functional configuration example of each equipment of the information processing system.

As illustrated in FIG. 6, the ToF sensor 1 includes a laser light pulse transmission unit 11 and an SPAD sensor unit 12.

The laser light pulse transmission unit 11 transmits spot-shaped pulse light toward the distance measurement range.

The SPAD sensor unit 12 detects reflected light from an object present in the distance measurement range and generates a histogram for each sparse distance measurement point. For example, the SPAD sensor unit 12 generates a histogram having 192 bins for each of 576 distance measurement points. The SPAD sensor unit 12 supplies the sparse histogram to the cost volume generation device 3.

The image sensor 2 supplies, for example, an RGB image of HD resolution to the cost volume generation device 3 and the three-dimensional model generation device 5.

The cost volume generation device 3 includes a histogram conversion unit 21, an initial cost volume generation unit 22, and a filtering unit 23.

The histogram conversion unit 21 performs conversion as shown in Formula (1) on the sparse histogram supplied from the SPAD sensor unit 12. In the conversion by the histogram conversion unit 21, first, the time of flight of 192 bins in the histogram is converted into a sample distance value d obtained by sampling a range from the SPAD sensor unit 12 (0 mm) to 10944 mm at intervals of 57 mm, for example. Next, for example, a value of (the maximum value of the number of photons for each distance measurement point)×0.3 is set as the threshold T, and for example, 100 is set as the cost c, and conversion as shown in Formula (1) is performed.

The histogram conversion unit 21 supplies the converted histogram to the initial cost volume generation unit 22.

The initial cost volume generation unit 22 generates an initial cost volume as represented by Formula (2) on the basis of the converted histogram supplied from the histogram conversion unit 21, and supplies the initial cost volume to the filtering unit 23.

The filtering unit 23 performs filtering with the edge-preserved filter on the initial cost volume supplied from the initial cost volume generation unit 22 as represented by Formula (3). For filtering by the edge-preserved filter, for example, an RGB image supplied from the image sensor 2 is used as a guide image. The filtering unit 23 supplies the filtered cost volume to the distance value estimation device 4.

The distance value estimation device 4 calculates a dense distance value on the basis of the cost volume supplied from the filtering unit 23, for example, as indicated by Formula (5). The dense distance value is indicated by, for example, a depth map of HD resolution. The distance value estimation device 4 supplies the dense distance value to the three-dimensional model generation device 5.

The three-dimensional model generation device 5 generates a three-dimensional model on the basis of the dense distance value supplied from the distance value estimation device 4 and the RGB image with the HD resolution supplied from the image sensor 2.

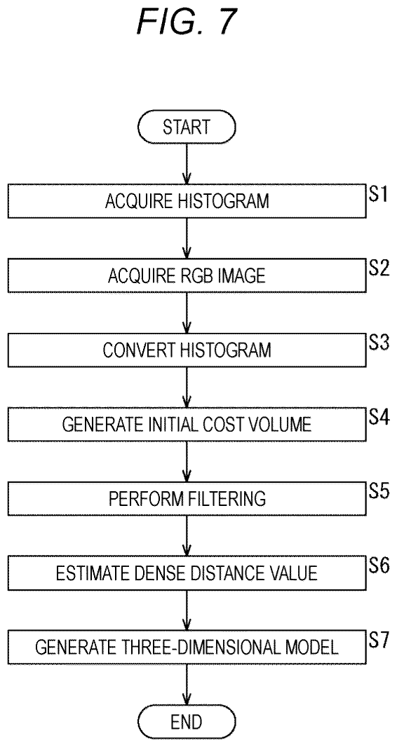

Next, processing performed by the information processing system having the above-described configuration will be described with reference to a flowchart of FIG. 7.

In step S1, the cost volume generation device 3 acquires the sparse histogram from the ToF sensor 1.

In step S2, the cost volume generation device 3 acquires the RGB image from the image sensor 2. The three-dimensional model generation device 5 acquires the same image as the RGB image acquired by the cost volume generation device 3 from the image sensor 2.

In step S3, the histogram conversion unit 21 of the cost volume generation device 3 converts the histogram.

In step S4, the initial cost volume generation unit 22 of the cost volume generation device 3 generates the initial cost volume on the basis of the converted histogram.

In step S5, the filtering unit 23 of the cost volume generation device 3 performs filtering with the edge-preserved filter on the initial cost volume.

In step S6, the distance value estimation device 4 estimates the dense distance value on the basis of the filtered cost volume.

In step S7, the three-dimensional model generation device 5 generates the three-dimensional model on the basis of the RGB image and the dense distance value.

In the above processing, the cost volume indicating the probability distribution of the distance to the object appearing in each pixel of the RGB image is generated on the basis of the sparse histogram acquired from the ToF sensor 1, and the dense distance value is estimated on the basis of the cost volume. By estimating the dense distance value using the cost volume, it is possible to accurately estimate the distance values at points other than the distance measurement point of the ToF sensor 1.

### 3. Second Embodiment of Information Processing System

In a case where the histogram cannot be acquired from the ToF sensor 1 and only the distance value for the distance measurement point can be acquired, the depth map can be generated using a cost volume generated on the basis of a distance value (distance measurement value) actually measured by the ToF sensor 1 instead of the histogram.

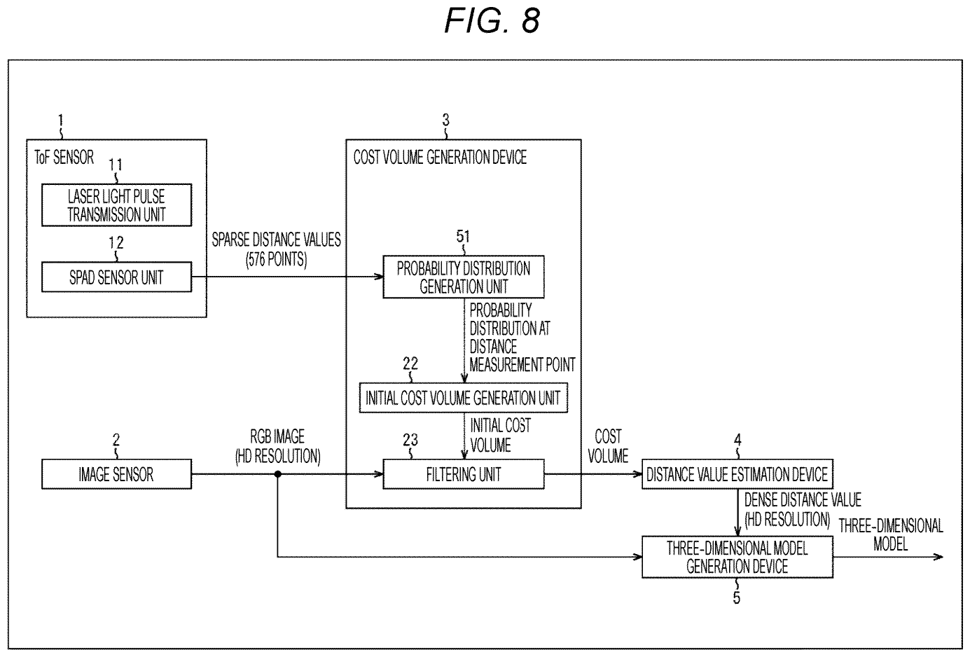

FIG. 8 is a block diagram illustrating a functional configuration example of each equipment of an information processing system according to a second embodiment of the present technology. In FIG. 8, the same configurations as those in FIG. 6 are denoted by the same reference signs. Redundant description will be omitted as appropriate.

A cost volume generation device 3 of FIG. 8 is different from the cost volume generation device 3 of FIG. 6 in including a probability distribution generation unit 51 instead of the histogram conversion unit 21.

An SPAD sensor unit 12 of a ToF sensor 1 acquires, for example, distance measurement values to an object at 576 distance measurement points as distance measurement data, and supplies sparse distance measurement values to the cost volume generation device 3.

The probability distribution generation unit 51 of the cost volume generation device 3 generates a probability distribution of the distance value for each distance measurement point on the basis of the distance measurement value for each distance measurement point supplied from the SPAD sensor unit 12. For example, the probability distribution generation unit 51 generates the probability distribution of the distance value at the distance measurement point by assigning a low cost to the sample distance value close to the distance measurement value and assigning a high cost to the other sample distance values.

Specifically, first, the probability distribution generation unit 51 calculates a weight w_{p_dToF} according to a difference between a distance measurement value d_{p_dToF} and the sample distance value. The weight w_{p_dToF} is represented by, for example, the following Formula (6).

$$\begin{matrix}[ Math . 6 ] & \\ {w}_{p \_ dToF} = \frac{{d}_{p\_dToF} - {d}_{0}}{{d}_{Δ}} - [ \frac{{d}_{p\_dToF} - {d}_{0}}{{d}_{Δ}} ] & ( 6 )\end{matrix}$$

In Formula (6), do represents a distance value from the ToF sensor 1 to the origin of the sample distance value. Each sample distance value is assigned a number (sample number) in order from the distance value closest to the origin. In Formula (6), the first term on the right side is a value obtained by normalizing the distance measurement value, and the second term on the right side indicates the sample number of the sample distance value closest to the distance measurement value among the sample distance values on the front side of the distance measurement value. The value obtained by normalizing the distance measurement value is a value corresponding to the sample number. In Formula (6), in a case where the distance measurement value and the sample distance value match, the weight w_{p_dToF} is 0.

Next, the probability distribution generation unit 51 generates a probability distribution of distance values for the distance measurement points using the weight w_{p_dToF}. A probability distribution P_{p_dToF,t} of the distance values for the distance measurement points is expressed by, for example, the following Formula (7).

$$\begin{matrix}[ Math . 7 ] & \\ {P}_{p\_dToF , t} = \{ \begin{matrix}c \times {w}_{p\_dToF} , t = [ \frac{{d}_{p\_dToF} - {d}_{0}}{{d}_{Δ}} ] \\ c \times ( 1 - {w}_{p\_dToF} ) , t = [ \frac{{d}_{p\_dToF} - {d}_{0}}{{d}_{Δ}} ] + 1 \\ c , otherwise\end{matrix} & ( 7 )\end{matrix}$$

In Formula (7), t represents a sampling number allocated to each sample distance value. In Formula (7), a value obtained by multiplying c by the weight w_{p_dToF} is assigned as a cost to a sample distance value to which a sample number immediately before a value obtained by normalizing a distance measurement value is allocated. Furthermore, a value obtained by multiplying c by a weight (1−w_{p_dToF}) is assigned as a cost to a sample distance value to which a sample number immediately after the value obtained by normalizing the distance measurement value is allocated. Moreover, c is assigned as a cost to sample distance values other than the sample distance values before and after the distance measurement value.

Note that, in the second embodiment, for example, a value larger than 0 is set as the cost c.

In a case where the distance measurement value matches the sample distance value, the cost assigned to the sample distance value matching the distance measurement value is 0, and the cost assigned to the other sample distance values is c. In this case, the probability distribution P_{p_dToF,t} is a probability distribution with a high kurtosis in which a sharp peak appears at one sample distance value. Furthermore, in a case where the distance measurement value and the sample distance value do not match, the cost assigned to the sample distance values before and after the distance measurement value is a value lower than c, and the cost assigned to the other sample distance values is c. In this case, the probability distribution P_{p_dToF,t} is a probability distribution with a high kurtosis in which two sample distance values sharply peak.

The probability distribution generation unit 51 supplies the probability distribution of the distance value for each distance measurement point to the initial cost volume generation unit 22.

The initial cost volume generation unit 22 generates an initial cost volume on the basis of the probability distribution supplied from the probability distribution generation unit 51. An initial cost volume C_{p,t} is represented by, for example, the following Formula (8).

$$\begin{matrix}[ Math . 8 ] & \\ {C}_{p , t} = \{ \begin{matrix}{P}_{p\_dToF , t} , p = p\_dToF \\ c , otherwise\end{matrix} & ( 8 )\end{matrix}$$

In Formula (8), the probability distribution P_{p_dToF,t} is stored as the cost for the pixel position p (=p_dToF) corresponding to the distance measurement point of the ToF sensor 1, and c is stored as the cost corresponding to all the sample distance values for the pixel positions p (≠p_dToF) other than the pixel position corresponding to the distance measurement point.

The initial cost volume generation unit 22 supplies the generated initial cost volume to the filtering unit 23.

The filtering unit 23 performs filtering using the edge-preserved filter on the initial cost volume supplied from the initial cost volume generation unit 22. A cost volume C′_{p,t} after filtering is expressed by, for example, the following Formula (9).

$$\begin{matrix}[ Math . 9 ] & \\ {C}_{p , t}^{′} = {\sum }_{q} {W}_{p , q} ( I ) {C}_{q , d} & ( 9 )\end{matrix}$$

The filtering unit 23 supplies the filtered cost volume to the distance value estimation device 4.

The distance value estimation device 4 calculates a dense distance value on the basis of the cost volume supplied from the filtering unit 23. A dense distance value fₚ is expressed by, for example, the following Formula (10).

$$\begin{matrix}[ Math . 10 ] & \\ {f}_{p} = Subpixel depth estimation ( {C}_{p , t}^{′} ) & ( 10 )\end{matrix}$$

In Formula (10), subpixel estimation (such as equiangular linear fitting or parabolic fitting) is performed for each pixel of the depth map on the basis of the filtered cost volume C′_{p,t}, thereby calculating the dense distance value fₚ. Note that the dense distance value fₚ may be estimated by setting the distance value with the minimum cost as the distance value for each pixel.

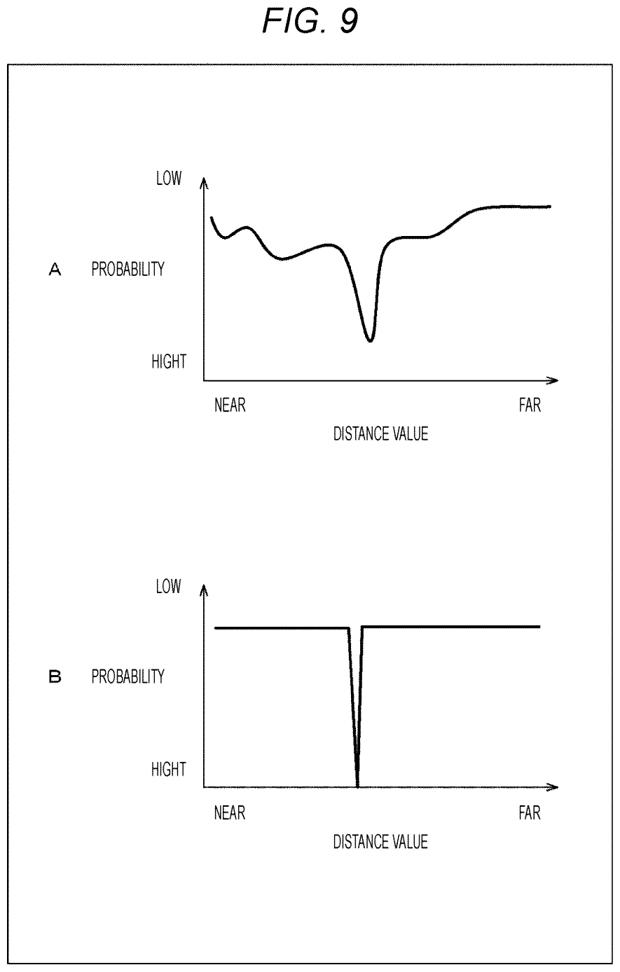

FIG. 9 is a diagram illustrating an example of a probability distribution of distance values. In FIG. 9, the horizontal axis represents a distance value, and the vertical axis represents a probability that an object is present.

A of FIG. 9 illustrates an example of a probability distribution of distance values for a predetermined pixel position in stereo matching and a probability distribution (histogram) of distance values for a predetermined distance measurement point acquired from the ToF sensor 1. On the other hand, B of FIG. 9 illustrates an example of a probability distribution of distance values for a predetermined distance measurement point based on the distance measurement value of the ToF sensor 1.

For example, the accuracy of the distance measurement value of the ToF sensor 1 is very high such that the variation is 0.5 mm or less, and an object exists at a position distant from the ToF sensor 1 by the distance measurement value with a high probability. Therefore, when the probability distribution of A of FIG. 9 is compared with the probability distribution of B of FIG. 9, the probability distribution of B of FIG. 9 has a high kurtosis.

By using the distance measurement value of the ToF sensor 1, the cost volume generation device 3 can generate a cost volume in which accuracy of the distance measurement value of the ToF sensor 1 is reflected and which has a probability distribution of high kurtosis. In the conventional upsampling technology, the estimation accuracy of the distance value for the contour portion of the object may be lowered. On the other hand, the information processing system of the present technology can accurately estimate the distance value for the contour portion of the object by three-dimensionally estimating the distance value using the cost volume.

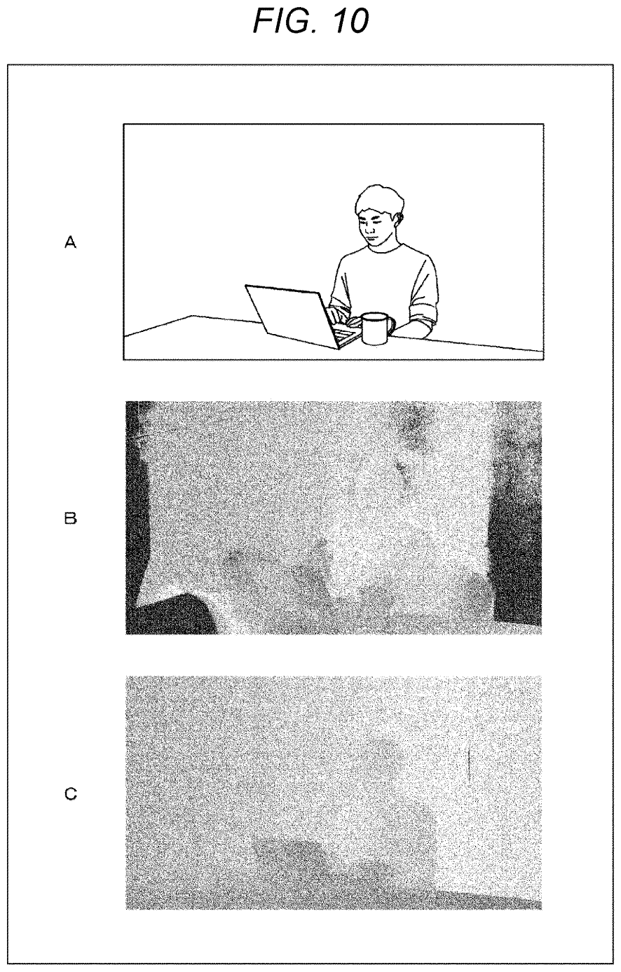

FIG. 10 is a diagram for comparing a depth map generated by stereo matching with a depth map generated by the present technology.

As illustrated in A of FIG. 10, for example, it is assumed that imaging is performed in an environment where the background is a white wall.

B of FIG. 10 illustrates an example of a depth map generated by conventional stereo matching using a stereo image captured in the environment as illustrated in A of FIG. 10. In the conventional stereo matching, estimation accuracy of a distance value for a low-frequency texture region such as a background may be low.

C of FIG. 10 illustrates an example of a depth map generated by the present technology using an RGB image captured in the environment as illustrated in A of FIG. 10 and distance measurement data of the ToF sensor 1. In the present technology, it is possible to accurately estimate the distance value for the low-frequency texture region as compared with the conventional stereo matching.

### 4. Use Case

The three-dimensional model generated by the information processing system according to the present technology can be converted into 3D content used in entertainment such as augmented reality (AR), virtual reality (VR), and metaverse.

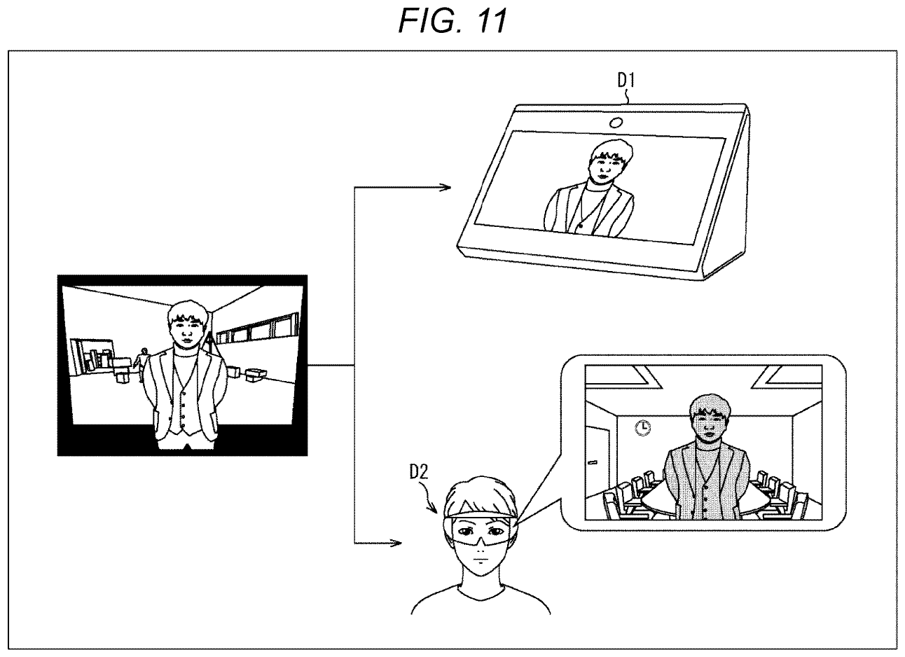

FIG. 11 is a diagram illustrating a display example of a 3D content.

The 3D content generated by converting the three-dimensional model is input to a space reproduction display D1 that displays an object capable of stereoscopic viewing, for example, as illustrated in the upper right of FIG. 11. On the space reproduction display D1, for example, an image of a person as a foreground in the three-dimensional model is displayed as an object that can be stereoscopically viewed.

Furthermore, the 3D content generated by converting the three-dimensional model is input to a glasses-type head mounted display (HMD) D2 compatible with AR and mixed reality (MR), for example, as illustrated on the lower right side of FIG. 11. For example, by displaying an image of the person as the foreground in the three-dimensional model on the HMD D2, a user wearing the HMD D2 can experience the augmented reality as if the person exists in the real space as illustrated in the balloon of FIG. 11.

The information processing system of the present technology can robustly estimate a distance value even in a low-frequency texture region (such as a white wall) in which it is difficult to estimate the distance value by the conventional stereo matching. Therefore, by using the three-dimensional model generated by the information processing system of the present technology for the production of the 3D content of the scene including the low-frequency texture region, it is possible to produce 3D content with high quality compared to the 3D content generated by the stereo matching or the like.

In the method of estimating a dense distance value using the cost volume based on the histogram acquired by the ToF sensor 1 (first embodiment), since many pieces of information called histograms are processed, it is assumed that it is difficult to perform processing in real time. Therefore, a use case is assumed in which the generation of the three-dimensional model and the conversion into the 3D content are performed offline, and the 3D content is provided.

On the other hand, in the method of estimating a dense distance value using the cost volume based on the distance value acquired by the ToF sensor 1 (second embodiment), there is a possibility that the processing can be performed in real time since there is little information to be processed. In a case where the processing can be performed in real time, for example, the information processing system of the present technology can be utilized as an in-vehicle sensor system.

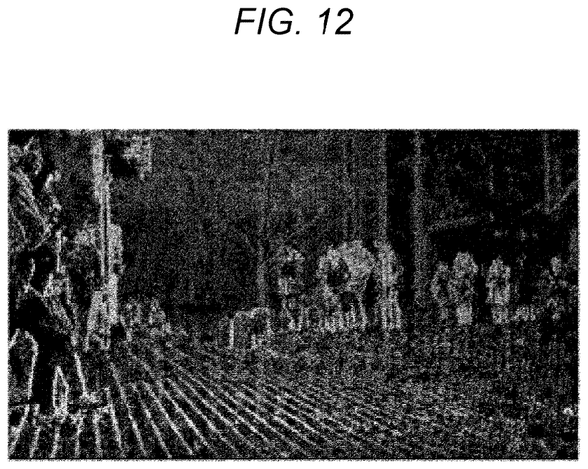

As illustrated in FIG. 12, a conventional in-vehicle stereo camera can acquire only a distance value of an edge portion of an object, but by utilizing the present technology, a dense distance value can be acquired, and there is a possibility that this can contribute to improvement in recognition accuracy of an object outside the vehicle.

Note that a cost volume based on the distance measurement data acquired by the ToF sensor 1 may be used for purposes other than upsampling of the distance measurement data, for example, as an input of neural radiance fields (NeRF).

### <Regarding Computer>

The series of processing described above can be performed by hardware or by software. In a case where the series of processing is executed by software, a program included in the software is installed from a program recording medium on a computer incorporated in dedicated hardware, a general-purpose personal computer, or the like.

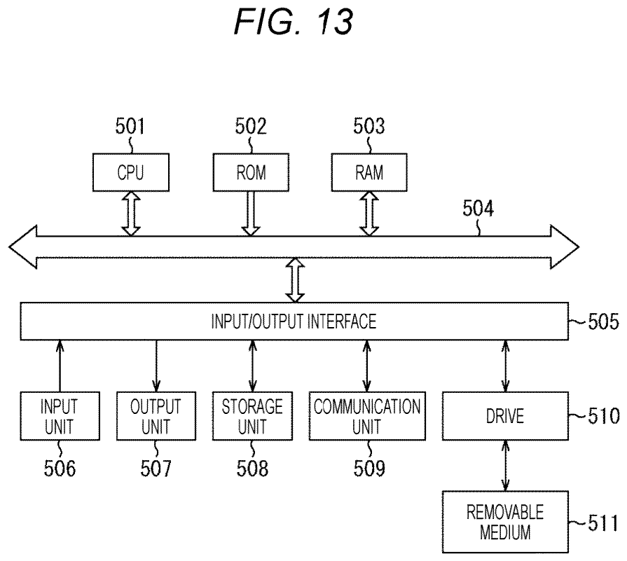

FIG. 13 is a block diagram illustrating a configuration example of the hardware of the computer that performs the above-described series of processing by means of the program.

A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a non-volatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present specification, or may be a program in which the processing is performed in parallel or at a necessary timing such as when a call is made.

Note that, in the present specification, a system means an assembly of a plurality of configuration elements (devices, modules (parts), and the like), and it does not matter whether or not all the configuration elements are located in the same housing. Therefore, a plurality of devices housed in separate housings and connected to each other via a network and one device in which a plurality of modules is housed in one housing are both systems.

Note that the effects described in the present specification are merely examples and are not limited, and other effects may be provided.

An embodiment of the present technology is not limited to the embodiment described above, and various modifications can be made without departing from the scope of the present technology.

For example, the present technology can have a configuration of cloud computing in which one function is shared and processed in cooperation by a plurality of devices via a network.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### <Combination Example of Configuration>

The present technology can also have the following configurations.

(1)

An information processing device including
a cost volume generation unit that generates a cost volume indicating a probability distribution of a distance to an object appearing in each pixel of a captured image on the basis of distance measurement data acquired by a ToF sensor.

(2)

The information processing device according to (1) described above, in which
the distance measurement data indicates a distance to the object for distance measurement points sparser than pixels of the captured image.

(3)

The information processing device according to (2) described above, in which
the cost volume generation unit generates the cost volume by performing filtering using an edge-preserved filter on an initial cost volume generated on the basis of the distance measurement data.

(4)

The information processing device according to (3) described above, in which
the distance measurement data includes a histogram of time of flight of pulse light corresponding to a distance to the object.

(5)

The information processing device according to (4) described above, in which
the cost volume generation unit performs conversion of multiplying a frequency of each bin of the histogram by a square of a distance corresponding to each bin.

(6)

The information processing device according to (4) or (5) described above, in which
the cost volume generation unit performs conversion of setting a frequency of a bin having a frequency smaller than a predetermined threshold as a predetermined value.

(7)

The information processing device according to (3) described above, in which
the distance measurement data includes a distance measurement value for the distance measurement point, the distance measurement value being measured by the ToF sensor.

(8)

The information processing device according to (7) described above, in which
the cost volume generation unit stores, in the initial cost volume, a probability distribution of a distance to the object for the distance measurement point, the probability distribution being generated on the basis of the distance measurement value, as a probability distribution of a distance to the object appearing in pixels of the captured image corresponding to the distance measurement point.

(9)

The information processing device according to (8), in which
the cost volume generation unit generates a probability distribution of a distance to the object for the distance measurement point using a weight according to a difference between the distance measurement value and a sample distance value sampled at a predetermined interval.

(10)

The information processing device according to (9) described above, in which
the cost volume generation unit generates a probability distribution of a distance to the object for the distance measurement point by, in a case where the sample distance value matching the distance measurement value is not present, assigning probability obtained by multiplying a predetermined value by the weight to the sample distance values before and after the distance measurement value and assigning a predetermined probability to another of the sample distance values, and by, in a case where the sample distance value matching the distance measurement value is present, assigning a probability obtained by multiplying a predetermined value by the weight to the sample distance value matching the distance measurement value and assigning a predetermined probability to another of the sample distance values.

(11)

The information processing device according to any one of (3) to (10) described above, in which
the cost volume generation unit stores a constant probability distribution in the initial cost volume as a probability distribution that the object exists for pixels other than a pixel corresponding to the distance measurement point.

(12)

The information processing device according to any one of (3) to (11) described above, in which
the edge-preserved filter includes a guided filter that uses the captured image as a guide image.

(13)

The information processing device according to any one of (1) to (12) described above, in which
the cost volume is used to generate a depth map having a resolution same as a resolution of the captured image.

(14)

The information processing device according to (13) described above, in which
the depth map is generated by subpixel estimation using the cost volume.

(15)

An information processing method including
generating, by an information processing device, a cost volume indicating a probability distribution of a distance to an object appearing in each pixel of a captured image on the basis of distance measurement data acquired by a ToF sensor.

(16)

A program for causing a computer to execute processing of
generating a cost volume indicating a probability distribution of a distance to an object appearing in each pixel of a captured image on the basis of distance measurement data acquired by a ToF sensor.

### REFERENCE SIGNS LIST

1 ToF sensor
2 Image sensor
3 Cost volume generation device
4 Distance value estimation device
5 Three-dimensional model generation device
11 Laser light pulse transmission unit
12 SPAD sensor unit
21 Histogram conversion unit
22 Initial cost volume generation unit
23 Filtering unit
51 Probability distribution generation unit

1. An information processing device comprising
a cost volume generation unit that generates a cost volume indicating a probability distribution of a distance to an object appearing in each pixel of a captured image on a basis of distance measurement data acquired by a ToF sensor.

2. The information processing device according to claim 1, wherein
the distance measurement data indicates a distance to the object for distance measurement points sparser than pixels of the captured image.

3. The information processing device according to claim 2, wherein
the cost volume generation unit generates the cost volume by performing filtering using an edge-preserved filter on an initial cost volume generated on a basis of the distance measurement data.

4. The information processing device according to claim 3, wherein
the distance measurement data includes a histogram of time of flight of pulse light corresponding to a distance to the object.

5. The information processing device according to claim 4, wherein
the cost volume generation unit performs conversion of multiplying a frequency of each bin of the histogram by a square of a distance corresponding to each bin.

6. The information processing device according to claim 4, wherein
the cost volume generation unit performs conversion of setting a frequency of a bin having a frequency smaller than a predetermined threshold as a predetermined value.

7. The information processing device according to claim 3, wherein
the distance measurement data includes a distance measurement value for the distance measurement point, the distance measurement value being measured by the ToF sensor.

8. The information processing device according to claim 7, wherein
the cost volume generation unit stores, in the initial cost volume, a probability distribution of a distance to the object for the distance measurement point, the probability distribution being generated on a basis of the distance measurement value, as a probability distribution of a distance to the object appearing in pixels of the captured image corresponding to the distance measurement point.

9. The information processing device according to claim 8, wherein
the cost volume generation unit generates a probability distribution of a distance to the object for the distance measurement point using a weight according to a difference between the distance measurement value and a sample distance value sampled at a predetermined interval.

10. The information processing device according to claim 9, wherein
the cost volume generation unit generates a probability distribution of a distance to the object for the distance measurement point by, in a case where the sample distance value matching the distance measurement value is not present, assigning a probability obtained by multiplying a predetermined value by the weight to the sample distance values before and after the distance measurement value and assigning a predetermined probability to another of the sample distance values, and by, in a case where the sample distance value matching the distance measurement value is present, assigning a probability obtained by multiplying a predetermined value by the weight to the sample distance value matching the distance measurement value and assigning a predetermined probability to another of the sample distance values.

11. The information processing device according to claim 3, wherein
the cost volume generation unit stores a constant probability distribution in the initial cost volume as a probability distribution that the object exists for pixels other than a pixel corresponding to the distance measurement point.

12. The information processing device according to claim 3, wherein
the edge-preserved filter includes a guided filter that uses the captured image as a guide image.

13. The information processing device according to claim 1, wherein
the cost volume is used to generate a depth map having a resolution same as a resolution of the captured image.

14. The information processing device according to claim 13, wherein
the depth map is generated by subpixel estimation using the cost volume.

15. An information processing method comprising
generating, by an information processing device, a cost volume indicating a probability distribution of a distance to an object appearing in each pixel of a captured image on a basis of distance measurement data acquired by a ToF sensor.

16. A program for causing a computer to execute processing of
generating a cost volume indicating a probability distribution of a distance to an object appearing in each pixel of a captured image on a basis of distance measurement data acquired by a ToF sensor.
